(19) United States
(12) Patent Application Publication
(10) Pub. No.: US 2014/0154582 A1
(43) Pub. Date: Jun. 5, 2014

(54) LITHIUM BATTERY AND METHOD FOR MANUFACTURING THE SAME

(71) Applicant: Industrial Technology Research Institute, Hsinchu (TW)

(72) Inventors: Chyi-Ming LEU, Jhudong Township (TW); Angelia Sulaiman LO, Taipei City (TW); Jen-Chih LO, Changhua City (TW)

(73) Assignee: INDUSTRIAL TECHNOLOGY RESEARCH INSTITUTE, Hsinchu (TW)

(21) Appl. No.: 13/901,223

(22) Filed: May 23, 2013

(30) Foreign Application Priority Data
Dec. 5, 2012 (TW) 101145580

(51) Int. Cl. H01M 10/658; H01M 10/058

(52) U.S. Cl. CPC H01M 10/5087; H01M 10/058
USPC 429/246; 29/623.5

(57) ABSTRACT

Disclosed is a lithium battery, including a positive electrode plate, a negative electrode plate, and a polyolefin separator disposed therebetween. An organic-inorganic hybrid film disposed between the polyolefin separator and the positive electrode plate, and/or disposed between the polyolefin separator and the negative electrode plate. The organic-inorganic hybrid film includes inorganic oxide particles and a fluorinated polymer binder, wherein the inorganic oxide particles and the fluorinated polymer binder have a weight ratio of about 40:60 to 80:20.

### CROSS-REFERENCE TO RELATED APPLICATIONS

The present application is based on, and claims priority from, Taiwan Application Serial Number 101145580, filed on Dec. 5, 2012, the disclosure of which is hereby incorporated by reference herein in its entirety

### TECHNICAL FIELD

The technical field relates to a lithium battery, and in particular, relates to an organic-inorganic hybrid film thereof.

### BACKGROUND

A conventional secondary battery such as lithium ion secondary battery is assembled by a positive electrode plate, a negative electrode plate, and a separator disposed therebetween. The separator may electrically insulate the positive electrode plate and the negative electrode plate, to prevent a short circuit when the positive electrode plate contacts with the negative electrode plate, and to adsorb/preserve electrolytes for conducting paths of lithium ions between the electrode plates. If a short circuit occurs in a conventional lithium battery, a large amount of heat will be released in a short period of time to melt or shrink the separator (e.g. polyolefin with low thermal resistance). If the local heat is not insulated and a short circuit is not terminated, active materials and organic electrolytes of the lithium battery will crack to form high pressure gas. In worse conditions, spontaneous combustion may occur.

Accordingly, a novel solution for the above problems of the lithium battery is called-for.

### SUMMARY

One embodiment of the disclosure provides a lithium battery, comprising: a positive electrode plate; a negative electrode plate; a polyolefin separator disposed between the positive electrode plate and the negative electrode plate; and an organic-inorganic hybrid film disposed between the polyolefin separator and the positive electrode plate, and/or disposed between the polyolefin separator and the negative electrode plate, wherein the organic-inorganic hybrid film comprises inorganic oxide particles and a fluorinated polymer binder, and the inorganic oxide particles and the fluorinated polymer binder have a weight ratio of about 40:60 to 80:20.

One embodiment of the disclosure provides a method of forming a lithium battery, comprising: mixing inorganic oxide particles, a fluorinated polymer binder, and solvent together to form a mixture; forming a film of the mixture; removing the solvent of the film to form an organic-inorganic hybrid film, wherein the organic-inorganic hybrid film comprises inorganic oxide particles and a fluorinated polymer binder, and the inorganic oxide particles and the fluorinated polymer binder have a weight ratio of about 40:60 to 80:20; disposing a polyolefin separator between a positive electrode plate and a negative electrode plate; and disposing the organic-inorganic hybrid film between the positive electrode plate and the polyolefin separator and/or between the negative electrode plate and the polyolefin separator.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGS. 1 to 3 show lithium batteries according to embodiments of the disclosure;

FIG. 4 shows voltage-period and temperature-period curves of a lithium battery after nail penetrating according to one embodiment of the disclosure; and

FIG. 5 shows size variation-temperature curves of films with different compositions according to one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

First, inorganic oxide particles, a fluorinated polymer binder, and solvent are mixed to form a mixture. Generally, the inorganic oxide particles are evenly dispersed in the solvent, and the fluorinated polymer binder is dissolved in the solvent. In one embodiment, the fluorinated polymer binder is dissolved in the solvent to form a fluorinated polymer solution, and the inorganic oxide particles are then dispersed in the fluorinated polymer solution. In another embodiment, the inorganic oxide particles are dispersed in the solvent to form a dispersion, and the fluorinated polymer binder is dissolved in another solvent to form a fluorinated polymer solution, respectively, and the dispersion and the fluorinated polymer solution are mixed. The solvent can be a polar solvent such as dimethylformamide (DMF), N,N-dimethylacetamide (DMAc), dimethyl sulfoxide (DMSO), other polar solvents, or combinations thereof.

The inorganic oxide particles can be silicon oxide, magnesium oxide, titanium oxide, zinc oxide, aluminum oxide, tin oxide, or combinations thereof. In one embodiment, the inorganic oxide particles have a diameter of about 10 nm to 300 nm. Overly small inorganic oxide particles cannot be efficiently adhered by the organic binder and therefore may easily peel due to an overly high specific surface area. In addition, overly small inorganic oxide particles may be packed too tight, thereby hindering penetration and transfer of lithium ions. Overly large inorganic oxide particles with overly low specific surface area will make the organic binder being excess, and the excess organic binder may hinder diffusion paths of lithium ions, thereby degrading the performance of the lithium battery.

The fluorinated polymer binder can be polytetrofluoroethylene (PTFE), tetrafluoroethylene-hexafluoropropylene copolymer (FEP), perfluoroalkoxy resin (PFA), polychlorotrifluoroethene (PCTFE), ethylene chlorotrifluoroethylene copolymer (ECTFE), tetrafluoroethylene-ethylene copolymer (ETFE), polyvinylidene difluoride (PVDF), polyvinyl fluoride (PVF), other fluorinated polymer binders, or combinations thereof. In one embodiment, the fluorinated polymer binder has a weight-average molecular weight of about 280,000 to 1,000,000, or of about 300,000 to 500,000. The inorganic oxide particles and the fluorinated polymer binder have a weight ratio of about 40:60 to 80:20.

Subsequently, the mixture of the inorganic oxide particles, the fluorinated polymer binder, and the solvent is used to form a film. The way to form the film can be general spin-on coating, dipping, blade coating, slit coating, spray coating, or other wet coatings. Subsequently, the solvent of the film is removed by a vacuum method, air drying method, heating method, or the likes to obtain an organic-inorganic hybrid film. In one embodiment, the organic-inorganic hybrid film has a thickness of about 1 μm to 10 μm, or of about 2 μm to 5 μm.

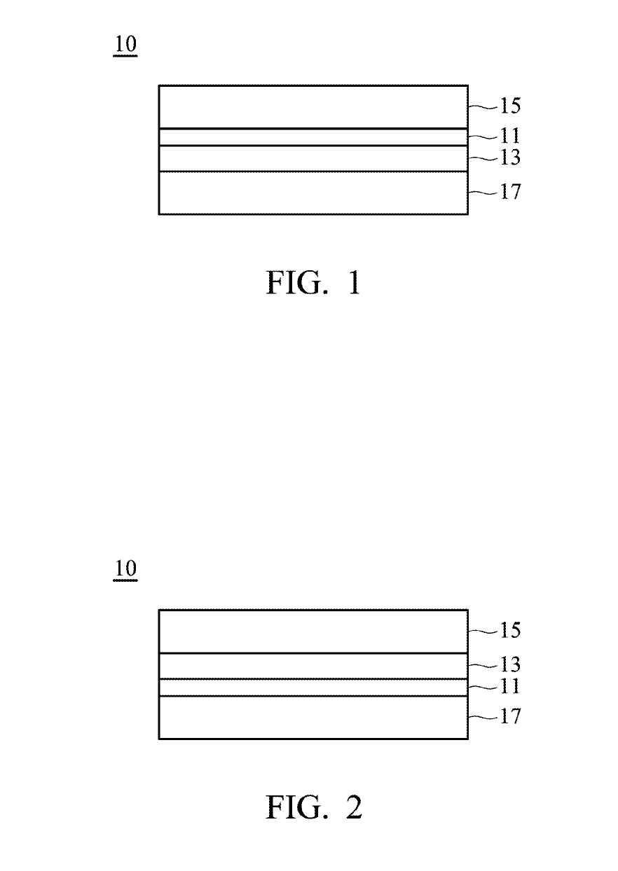

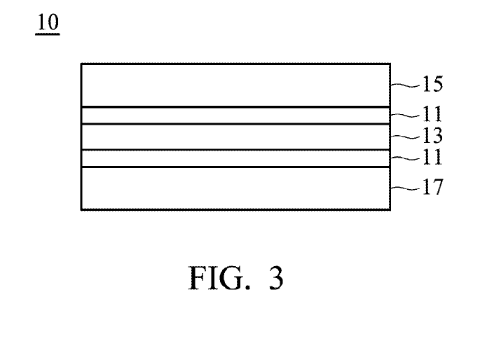

Next, the organic-inorganic hybrid film 11 is disposed between the polyolefin separator 13 and the positive electrode plate 15 in the lithium battery 10, as shown in FIG. 1. In another embodiment, the organic-inorganic hybrid film 11 is disposed between the polyolefin separator 13 and the negative electrode plate 17, as shown in FIG. 2. In a further embodiment, the organic-inorganic hybrid film 11 is disposed between the polyolefin separator 13 and the positive electrode plate 15, and the other organic-inorganic hybrid film 11 is disposed between the polyolefin film 13 and the negative electrode plate 17, as shown in FIG. 3.

Note that the mixture of the inorganic oxide particles, the fluorinated polymer binder, and the solvent is not used to directly form a film on the positive electrode plate 15 or the negative electrode plate 17. The inorganic oxide particles of the mixture may fill pores of the positive electrode plate 15 or the negative electrode plate 17 to form the non-flat film, such that the non-flat film has lower mechanical properties (e.g. flexibility and thermal resistance). In addition, the filled pores of the electrode plate may hinder the diffusion of the lithium ions, thereby increasing the impedance of the lithium battery. On the other hand, the mixture of the inorganic oxide particles, the fluorinated polymer binder, and the solvent is not used to directly form a film on the polyolefin separator 13, thereby preventing the polyolefin separator from being damaged during the step of removing solvent of the film at a high temperature. According to the embodiments, an organic-inorganic hybrid film with physical flexibility, excellent thermal resistance, and good process flexibility can be obtained by independently forming the organic-inorganic hybrid film and then disposing it between the positive electrode plate and the polyolefin separator and/or between the negative electrode plate and the polyolefin separator.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Preparation Example 1

### Preparation of Mesoporous Aluminum Oxide Powder Material

10.23 g of hexadecyltrimethylammonium bromide (CTAB) was dissolved in 50 g of de-ionized water, and 7.24 g of aluminium isopropanolate (AIP) was then added into the CTAB solution and stirred at room temperature for 30 minutes. The solution was tuned by nitric acid (10 wt %) to achieve a pH value of 4.5, and then aging-treated for 5 hours. The solution was then put into an oven at 110° C. for 15 hours to form powders by polymerization. The powders were washed and then sintered at 650° C. for 5 hours to obtain 8.6 g of a mesoporous aluminum oxide powder material with a pore size of 2 nm to 50 nm (determined by X-ray diffraction (XRD) and transmission electron microscopy (TEM)).

### Example 1

### An Organic-Inorganic Hybrid Film of the Mesoporous Aluminum Oxide Powders and PVDF

4 g of the mesoporous aluminum oxide powder material in Preparation Example 1, and 6 g of PVDF (KF1300, commercially available from Kureha, Mw=350,000) were mixed in 90 g of DMAc and stirred at room temperature for 3 hours to obtain 100 g of a dispersion (solid content was 10 wt %, wherein the mesoporous aluminum oxide powder material and the PVDF had a weight ratio of 40:60). The dispersion was coated on a substrate by a 60 μm blade, and then baked at 50° C. for 5 minutes, 140° C. for 5 minutes, and 210° C. for 5 minutes, respectively, to obtain an organic-inorganic hybrid film with a thickness of 2 μm to 3 μm. The organic-inorganic hybrid film was flexible and arbitrarily rolled.

### Example 2

### An Organic-Inorganic Hybrid Film of 13 nm Aluminum Oxide Powders and PVDF

4 g of the 13 nm aluminum oxide (Gamma aluminum oxide, commercially available from Union Chemical Ind. Co., Ltd., Taiwan), and 6 g of PVDF (KF1300, commercially available from Kureha) were mixed in 90 g of DMAc and stirred at room temperature for 3 hours to obtain 100 g of a dispersion (solid content was 10 wt %, wherein the 13 nm aluminum oxide and the PVDF had a weight ratio of 40:60). The dispersion was coated on a substrate by a 60 μm blade, and then baked at 50° C. for 5 minutes, 140° C. for 5 minutes, and 210° C. for 5 minutes, respectively, to obtain an organic-inorganic hybrid film with a thickness of 2 μm to 3 μm. The organic-inorganic hybrid film was flexible and arbitrarily rolled.

### Example 3

### An Organic-Inorganic Hybrid Film of 300 nm Aluminum Oxide and PVDF

4 g of the 300 nm aluminum oxide (Alpha aluminum oxide, commercially available from LECO), and 6 g of PVDF (KF1300, commercially available from Kureha) were mixed in 90 g of DMAc and stirred at room temperature for 3 hours to obtain 100 g of a dispersion (solid content was 10 wt %, wherein the 300 nm aluminum oxide and the PVDF had a weight ratio of 40:60). The dispersion was coated on a substrate by a 60 μm blade, and then baked at 50° C. for 5 minutes, 140° C. for 5 minutes, and 210° C. for 5 minutes, respectively, to obtain an organic-inorganic hybrid film with a thickness of 2 μm to 3 μm. The organic-inorganic hybrid film was flexible and arbitrarily rolled.

### Example 4

### A Thin Lithium Battery with the Organic-Inorganic Hybrid Film

The organic-inorganic hybrid film of the mesoporous aluminum oxide and PVDF in Example 1 was disposed between a polyethylene (PE) separator (N9620, commercially available from Asahi) and a super fine mesophase graphite powder negative electrode plate (SMGP-A, commercially available from China Steel Chemical Corporation). A lithium nickel manganese cobalt-lithium manganese positive electrode plate (LNMC-LM, commercially available from Amita) was disposed on another side of the PE separator. The positive electrode plate, the separator, the organic-inorganic hybrid film, and the negative electrode plate were assembled to form a lithium battery of pouch type (50 mm×40 mm×1.5 mm), wherein the electrolyte thereof was 1.1M LiPF₆ in propylene carbonate/ethylene carbonate/diethylene carbonate (PC/EC/DEC) with a volume ratio of 2:3:5. The thin lithium battery was laid aside for 8 hours, and then measured by an alternating-current impedance analyzer of 1 kHz to obtain the cell impedance. The thin lithium battery was formatted by charge/discharge cycles of 0.1 C/0.1 C to measure its electrical properties and irreversible capacitance, as tabulated in Table 1.

### Example 5

### A Thin Lithium Battery with the Organic-Inorganic Hybrid Film

The organic-inorganic hybrid film of the 13 nm aluminum oxide and PVDF in Example 2 was disposed between a PE separator (N9620, commercially available from Asahi) and a super fine mesophase graphite powder negative electrode plate (SMGP-A, commercially available from China Steel Chemical Corporation). A lithium nickel manganese cobalt-lithium manganese positive electrode plate (LNMC-LM, commercially available from Amita) was disposed on another side of the PE separator. The positive electrode plate, the separator, the organic-inorganic hybrid film, and the negative electrode plate were assembled to form a lithium battery of pouch type (50 mm×40 mm×1.5 mm), wherein the electrolyte thereof was 1.1M LiPF₆ in PC/EC/DEC with a volume ratio of 2:3:5. The thin lithium battery was laid aside for 8 hours, and then measured by an alternating-current impedance analyzer of 1 kHz to obtain the cell impedance. The thin lithium battery was formatted by charge/discharge cycles of 0.1 C/0.1 C to measure its electrical properties and irreversible capacitance, as tabulated in Table 1.

### Example 6

### A Thin Lithium Battery with the Organic-Inorganic Hybrid Film

The organic-inorganic hybrid film of the 300 nm aluminum oxide and PVDF in Example 3 was disposed between a PE separator (N9620, commercially available from Asahi) and a super fine mesophase graphite powder negative electrode plate (SMGP-A, commercially available from China Steel Chemical Corporation). A lithium nickel manganese cobalt-lithium manganese positive electrode plate (LNMC-LM, commercially available from Amita) was disposed on another side of the PE separator. The positive electrode plate, the separator, the organic-inorganic hybrid film, and the negative electrode plate were assembled to form a lithium battery of pouch type (50 mm×40 mm×1.5 mm), wherein the electrolyte thereof was 1.1M LiPF₆ in PC/EC/DEC with a volume ratio of 2:3:5. The thin lithium battery was laid aside for 8 hours, and then measured by an alternating-current impedance analyzer of 1 kHz to obtain the cell impedance. The thin lithium battery was formatted by charge/discharge cycles of 0.1 C/0.1 C to measure its electrical properties and irreversible capacitance, as tabulated in Table 1.

### Comparative Example 1

### A Thin Lithium Battery without an Organic-Inorganic Hybrid Film

A PE separator (N9620, commercially available from Asahi) was disposed between a super fine mesophase graphite powder negative electrode plate (SMGP-A, commercially available from China Steel Chemical Corporation) and a lithium nickel manganese cobalt-lithium manganese positive electrode plate (LNMC-LM, commercially available from Amita). The positive electrode plate, the separator, and the negative electrode plate were assembled to form a lithium battery of pouch type (50 mm×40 mm×1.5 mm), wherein the electrolyte thereof was 1.1M LiPF₆ in PC/EC/DEC with a volume ratio of 2:3:5. The thin lithium battery was laid aside for 8 hours, and then measured by an alternating-current impedance analyzer of 1 kHz to obtain the cell impedance. The thin lithium battery was formatted by charge/discharge cycles of 0.1 C/0.1 C to measure its electrical properties and irreversible capacitance, as tabulated in Table 1.

As shown by the comparisons in Table 1, the thin lithium battery with the organic-inorganic hybrid film in Examples 4 to 6 had similar electrical properties to that of the thin film lithium battery without the organic-inorganic hybrid film in Comparative Example 1. Accordingly, the organic-inorganic hybrid film might reduce the problem of internal short circuit of a lithium battery, and not obviously negatively influence the electrical properties of the lithium battery utilizing the same.

TABLE 1

| | | | 1^{st} charge/discharge cycle | | | 2^{nd} charge/discharge cycle | | | 3^{rd} Charge |
|---|---|---|---|---|---|---|---|---|---|
| | Lithium battery | | (0.1 C/0.1 C) | | | (0.1 C/0.1 C) | | | (0.1 C) |
| | after formation | | Charge | Discharge | Irreversible | Charge | Discharge | Irreversible | Charge |
| | Impedance | | capacitance | capacitance | capacitance | capacitance | capacitance | capacitance | capacitance |
| Battery | (Ω) | Voltage | (mAh/g) | (mAh/g) | (%) | (mAh/g) | (mAh/g) | (%) | (mAh/g) |
| Comparative | 1.437 | 4.1902 | 164.25 | 132.1 | 19.60% | 130.63 | 132.06 | −1.10% | 132.76 |
| Example 1-1 | | | | | | | | | |
| Comparative | 1.446 | 4.1907 | 162.96 | 132.27 | 18.80% | 131.14 | 132.24 | −0.80% | 133.07 |
| Example 1-2 | | | | | | | | | |
| Comparative | 1.388 | 4.1893 | 163.66 | 131.69 | 19.50% | 131.68 | 131.65 | 0.00% | 133.48 |
| Example 1-3 | | | | | | | | | |
| Average | 1.424 | 4.19 | 163.62 | 132.02 | 19.30% | 131.15 | 131.98 | −0.60% | 133.1 |
| Example 4-1 | 1.32 | 4.1897 | 160.69 | 131.93 | 17.90% | 131.05 | 131.9 | −0.60% | 133.34 |
| Example 4-2 | 1.303 | 4.1879 | 156.81 | 131.87 | 15.90% | 130.81 | 131.84 | −0.80% | 131.31 |
| Example 4-3 | 1.367 | 4.1882 | 160.45 | 131.96 | 17.80% | 130.39 | 131.92 | −1.20% | 132.77 |
| Average | 1.33 | 4.189 | 159.32 | 131.92 | 17.20% | 130.75 | 131.89 | −0.90% | 132.47 |
| Example 5-1 | 1.336 | 4.1878 | 162.69 | 131.97 | 18.90% | 130.95 | 131.92 | −0.70% | 133.76 |
| Example 5-2 | 1.278 | 4.1884 | 161.41 | 132.07 | 18.20% | 130.27 | 132.04 | −1.40% | 133.36 |
| Example 5-3 | 1.306 | 4.1892 | 161.38 | 131.97 | 18.20% | 130.72 | 131.93 | −0.90% | 133.09 |
| Average | 1.307 | 4.188 | 161.83 | 132 | 18.40% | 130.65 | 131.96 | −1.00% | 133.4 |
| Example 6-1 | 1.882 | 4.1653 | 163.88 | 128.34 | 21.70% | 130.19 | 124.33 | 4.50% | 125.54 |
| Example 6-2 | 1.627 | 4.1643 | 165.37 | 128.2 | 22.50% | 130.01 | 124.23 | 4.40% | 125.29 |
| Example 6-3 | 1.846 | 4.1615 | 159.33 | 123.2 | 22.70% | 125.41 | 118.82 | 5.30% | 120.48 |
| Average | 1.785 | 4.164 | 162.86 | 126.58 | 22.30% | 128.54 | 122.46 | 4.70% | 123.77 |

### Example 7

### A Prismatic Type Lithium Battery with the Organic-Inorganic Hybrid Film

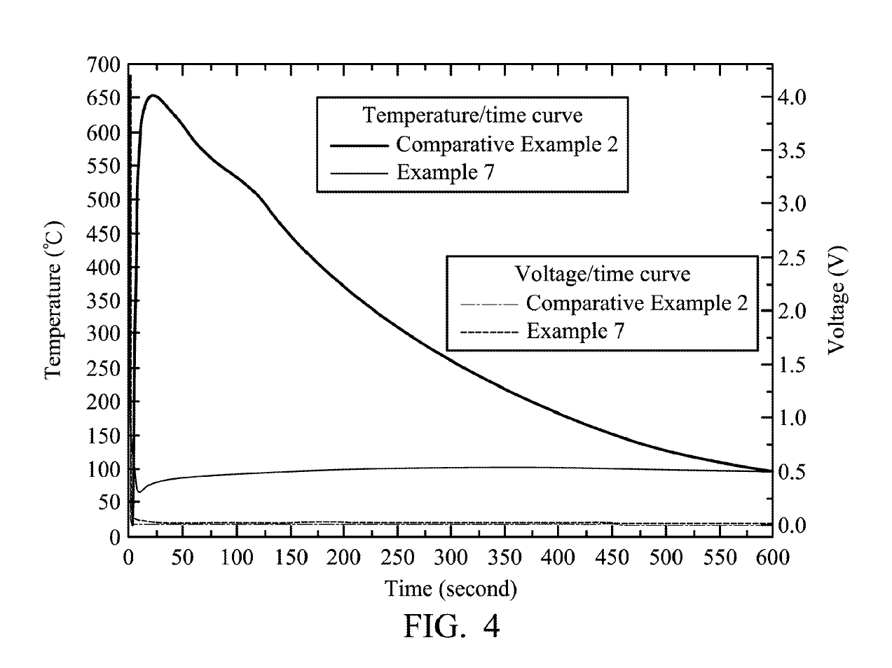

The organic-inorganic hybrid film of the 13 nm aluminum oxide and PVDF in Example 2 was disposed between a PE separator (N9620, commercially available from Asahi) and a super fine mesophase graphite powder negative electrode plate (SMGP-A, commercially available from China Steel Chemical Corporation). A lithium cobalt oxide positive electrode plate (LiCoO₂, commercially available from LICO) was disposed on the other side of the PE separator. The positive electrode plate, the separator, and the negative electrode plate were assembled to form a prismatic type lithium battery (5 mm×37 mm×59 mm), wherein the electrolyte thereof was 1.1M LiPF₆ in PC/EC/DEC with a volume ratio of 2:3:5. The prismatic type lithium battery was laid aside for 8 hours, and then measured by an alternating-current impedance analyzer of 1 kHz to obtain the cell impedance. The prismatic type lithium battery was formatted by charge/discharge cycles of 0.1 C/0.1 C to measure its electrical properties and irreversible capacitance, as tabulated in Table 2. After being charged to 4.2V, the prismatic type lithium battery was penetrated by a nail to check its safety. The temperature-period curve of the prismatic type lithium battery after nail penetrating is shown in FIG. 4.

### Comparative Example 2

### A Prismatic Type Lithium Battery without an Organic-Inorganic Hybrid Film

A PE separator (N9620, commercially available from Asahi) was disposed between a super fine mesophase graphite powder negative electrode plate (SMGP-A, commercially available from China Steel Chemical Corporation) and a lithium cobalt oxide positive electrode plate (LiCoO₂, commercially available from LICO). The positive electrode plate, the separator, and the negative electrode plate were assembled to form a prismatic type lithium battery (5 mm×37 mm×59 mm), wherein the electrolyte thereof was 1.1M LiPF₆ in PC/EC/DEC with a volume ratio of 2:3:5. The prismatic type lithium battery was laid aside for 8 hours, and then measured by an alternating-current impedance analyzer of 1 kHz to obtain the cell impedance. The prismatic type lithium battery was formatted by charge/discharge cycles of 0.1 C/0.1 C to measure its electrical properties and irreversible capacitance, as tabulated in Table 2. After being charged to 4.2V, the prismatic type lithium battery was penetrated by a nail to check its safety. The temperature-period curve of the prismatic type lithium battery after nail penetrating is shown in FIG. 4.

As shown in FIG. 4, the voltage of the prismatic type lithium batteries in Example 7 and Comparative Example 2 quickly reduced to 0V after the nail penetrating. The temperature of the prismatic type lithium battery in Example 7 was elevated from about 50° C. to about 100° C. after the nail penetrating. The temperature of the prismatic type lithium battery in Comparative Example 2 was elevated from about 50° C. to about 650° C. with an appearance of scorch and damage after the nail penetrating. Accordingly, the prismatic type lithium battery with the organic-inorganic hybrid film may efficiently prevent fast heating caused from the internal short circuit.

As shown by the comparisons in Table 2, the prismatic type lithium battery with the organic-inorganic hybrid film in Example 7 had similar electrical properties to that of the prismatic type lithium battery without the organic-inorganic hybrid film in Comparative Example 2. Accordingly, the organic-inorganic hybrid film might reduce the problem of internal short circuit of a prismatic type lithium battery, and not obviously negatively influence the electrical properties of the lithium battery utilizing the same.

TABLE 2

| | 1^{st} charge/discharge cycle | | | 2^{nd} charge/discharge cycle | | | Final test | |
|---|---|---|---|---|---|---|---|---|
| | Charge | Discharge | | Charge | Discharge | | Internal | |
| | capacitance | capacitance | Irreversible | capacitance | capacitance | Irreversible | resistance | |
| Battery | (mAh/g) | (mAh/g) | capacitance (%) | (mAh/g) | (mAh/g) | capacitance (%) | (mΩ) | Voltage (V) |
| Example 7 | 1412 | 1213 | 14% | 1225 | 1176 | 4% | 36.0 | 4.13 |
| Comparative | 1403 | 1190 | 15% | 1216 | 1158 | 5% | 31.2 | 4.14 |
| Example 2 | | | | | | | | |

### Example 8

### Physical Properties of the Organic-Inorganic Hybrid Film

The dispersion in Example 2 was coated on a substrate by a 250 μm blade, and then baked at 50° C. for 5 minutes, 140° C. for 5 minutes, and 210° C. for 5 minutes, respectively, to obtain an organic-inorganic hybrid film with a thickness of 11 μm to 13 μm. 10 g of PVDF (KF1300 commercially available from Kureha) was dissolved in 90 g of DMAc and stirred at room temperature for 3 hours to obtain 100 g of PVDF solution (solid content was 10 wt %). The PVDF solution was coated on a substrate by a 750 μm blade, and then baked at 50° C. for 5 minutes, 140° C. for 5 minutes, and 210° C. for 5 minutes, respectively, to obtain a PVDF film with a thickness of 20 μm.

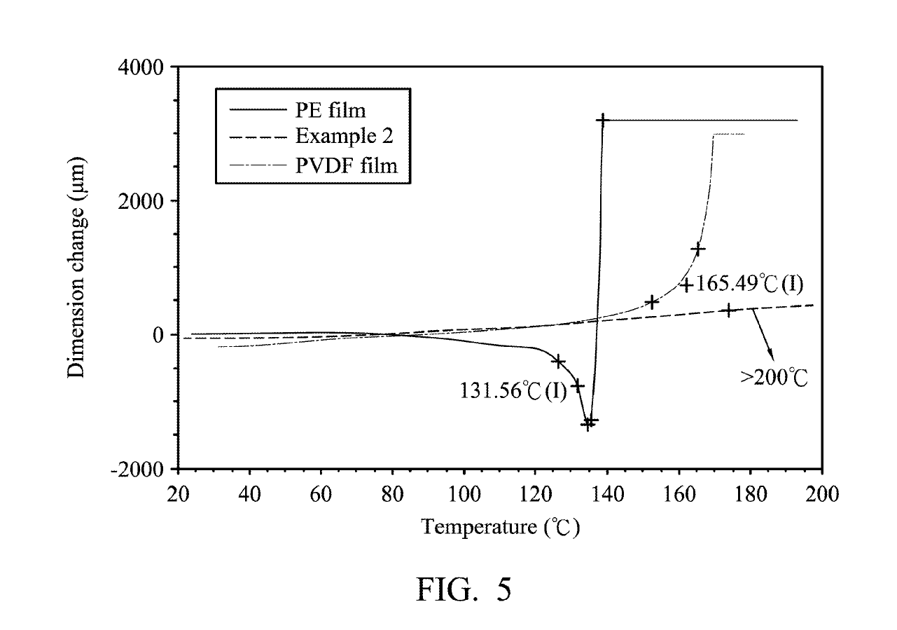

The organic-inorganic hybrid film, a 20 μm PE film (N9620 commercially available from Asahi), and the PVDF film were measured by a thermal mechanical analyzer (TMA) to obtain the size variations of the films at different temperature, as shown in FIG. 5. The organic-inorganic hybrid film did not dramatically change until 200° C., the PE film contracted at about 130° C., and PVDF film dramatically expanded at about 165. Obviously, the organic-inorganic hybrid film has a better thermal resistance than the PE film and the PVDF film.

The organic-inorganic hybrid film and the PE film were put into an oven at 120° C. for 1 hour to measure their size variation. The organic-inorganic hybrid film had a contraction ratio of less than 1%, and the PE film had a contraction ratio of about 15%. With the organic-inorganic hybrid film and the PE film used together, the organic-inorganic hybrid film with a negligible contraction ratio may insulate the positive and negative electrode plates, thereby reducing the short circuit caused from the PE film contraction (about 15%). The organic-inorganic hybrid film and the PE film were measured by a QCTECH tensile tester to obtain the mechanical strength of the films. The organic-inorganic hybrid film had a Young's modulus of 2.345 GPa, and the PE film had a Young's modulus of 0.925 GPa. As such, the thinner organic-inorganic hybrid film had a higher mechanical strength than that of the thicker PE film.

The organic-inorganic hybrid film was dipped into a 1.1M LiPF₆ solution in PC/EC/DEC with a volume ratio of 2:3:5 for 1 month, and the film remained therein without dissolving or deformation.

Furthermore, the thermal resistance material (e.g. high content ratio of inorganic oxide particles and low content ratio of organic polymer binder) of the commercially available product was directly coated on a surface of the electrode plate or the separator. The internal resistance of the battery was easily increased by the coating, and the inorganic oxide filler in the coating easily peeled when used and therefore lost its protection effect. Moreover, the coating formed of thermal resistance material was brittle, such that the coating easily peeled or cracked during the electrode plate and the separator were assembled.

For example, the cylindrical lithium battery 18650 (commercially available from Panasonic) was taken apart; thereby obtaining a negative electrode plate with a surface coated a thermal resistance material. After rolling the negative electrode plate, the thermal resistance material cracked and peeled. However, the organic-inorganic hybrid film with excellent flexibility and thermal resistance may be disposed between the electrode plate and the polyolefin separator, which would make the polyolefin separator free of cracking or peeling even if the electrode plate/polyolefin separator were rolled.

It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. A lithium battery, comprising:
a positive electrode plate;
a negative electrode plate;
a polyolefin separator disposed between the positive electrode plate and the negative electrode plate;
an organic-inorganic hybrid film disposed between the polyolefin separator and the positive electrode plate, and/or disposed between the polyolefin separator and the negative electrode plate,
wherein the organic-inorganic hybrid film comprises inorganic oxide particles and a fluorinated polymer binder, and the inorganic oxide particles and the fluorinated polymer binder have a weight ratio of about 40:60 to 80:20.

2. The lithium battery as claimed in claim 1, wherein the organic-inorganic hybrid film has a thickness of 1 μm to 10 μm.

3. The lithium battery as claimed in claim 1, wherein the inorganic oxide particles comprise silicon oxide, magnesium oxide, titanium oxide, zinc oxide, aluminum oxide, tin oxide, or combinations thereof.

4. The lithium battery as claimed in claim 1, wherein the inorganic particles have a diameter of 10 nm to 300 nm.

5. The lithium battery as claimed in claim 1, wherein the fluorinated polymer binder comprises polytetrofluoroethylene (PTFE), tetrafluoroethylene-hexafluoropropylene copolymer (FEP), perfluoroalkoxy (PFA) resin, polychlorotrifluoroethene (PCTFE), ethylene chlorotrifluoroethylene copolymer (ECTFE), ethylene-tetrafluoroethylene copolymer (ETFE), polyvinylidene difluoride (PVDF), polyvinyl fluoride (PVF), or combinations thereof.

6. The lithium battery as claimed in claim 1, wherein the fluorinated polymer binder has a weight-average molecular weight of 280,000 to 1,000,000.

7. A method of forming a lithium battery, comprising:
mixing inorganic oxide particles, a fluorinated polymer binder, and solvent to form a mixture;
forming a film of the mixture;
removing the solvent of the film to form an organic-inorganic hybrid film, wherein the organic-inorganic hybrid film comprises inorganic oxide particles and a fluorinated polymer binder, and the inorganic oxide particles and the fluorinated polymer binder have a weight ratio of about 40:60 to 80:20;
disposing a polyolefin separator between a positive electrode plate and a negative electrode plate; and
disposing the organic-inorganic hybrid film between the positive electrode plate and the polyolefin separator and/or between the negative electrode plate and the polyolefin separator.

8. The method as claimed in claim 7, wherein the organic-inorganic hybrid film has a thickness of 1 μm to 10 μm.

9. The method as claimed in claim 7, wherein the inorganic oxide particles comprise silicon oxide, magnesium oxide, titanium oxide, zinc oxide, aluminum oxide, tin oxide, or combinations thereof.

10. The method as claimed in claim 7, wherein the inorganic particles have a diameter of 10 nm to 300 nm.

11. The method as claimed in claim 7, wherein the fluorinated polymer binder comprises polytetrofluoroethylene (PTFE), tetrafluoroethylene-hexafluoropropylene copolymer (FEP), perfluoroalkoxy (PFA) resin, polychlorotrifluoroethene (PCTFE), ethylene chlorotrifluoroethylene copolymer (ECTFE), ethylene-tetrafluoroethylene copolymer (ETFE), polyvinylidene difluoride (PVDF), polyvinyl fluoride (PVF), or combinations thereof.

12. The method as claimed in claim 7, wherein the fluorinated polymer binder has a weight-average molecular weight of 280,000 to 1,000,000.
